(19) United States
(12) Patent Application Publication
(10) Pub. No.: US 2012/0200228 A1
(43) Pub. Date: Aug. 9, 2012

(54) LIGHT SOURCE APPARATUS AND DISPLAY APPARATUS

(75) Inventor: Tsukasa Fujita, Osaka-shi (JP)

(73) Assignee: SHARP KABUSHIKI KAISHA, Osaka-shi, Osaka (JP)

(21) Appl. No.: 13/501,758

(22) PCT Filed: May 27, 2010
(86) PCT No.: PCT/JP2010/059035

§ 371 Date: Apr. 13, 2012

(30) Foreign Application Priority Data
Oct. 30, 2009 (JP) 2009-249846

(51) Int. Cl. H05B 37/00

(52) U.S. Cl. 315/161

(57) ABSTRACT

In order to provide an apparatus that is capable of being driven with low power consumption by optimizing efficiency of each light emitting element regardless of which luminance mode is selected, a light source apparatus in accordance with the present invention includes a plurality of LEDs (50) (light emitting elements), said light source apparatus having a first luminance mode and a second luminance mode, the second luminance mode being a mode in which the light source apparatus is driven so that luminance is lower than luminance in the first luminance mode, the plurality of LEDs (50) being classified into (i) a first group (LEDs (50a) and LEDs (50b)) for use in the first luminance mode and (ii) a second group (LEDs (50b)) for use in the second luminance mode, and in a part of a light emitting element area (51) where the plurality of LEDs (50) are provided, LEDs (50) that belong to the second group being distributed less densely than LEDs (50) that belong to the first group.

### TECHNICAL FIELD

The present invention relates to a light source apparatus and a display apparatus.

### BACKGROUND ART

In recent years, there is introduced a new viewing style for television. In the new viewing style, an ultraslim large-screen television set such as a liquid crystal television set, which is capable of displaying high quality images and playing high quality sounds, is hung on a wall or attached to a wall-mounted stand, and displays a still image such as a painting or a picture (collectively called as “ornamental image”) so that the image is enjoyed while no television image is being viewed. Under such circumstances, for example in a large-screen television set, there is a further demand for a technique of displaying an ornamental image etc. while consuming as less power as possible.

Meanwhile, there have been proposed for televisions various techniques of carrying out power-saving drive suitable for various usage patterns, regardless of whether or not an ornamental image etc. is displayed.

For example, Patent Literatures 1 and 2 each disclose an LED backlight device, which consumes less power and is suitable for use in a liquid crystal television set etc. The LED backlight device described in Patent Literature 1 achieves power-saving drive by controlling LEDs not to emit light, which LEDs correspond to areas (black display areas) in a liquid crystal panel in which areas black displays are carried out.

The LED backlight device described in Patent Literature 2 achieves power-saving drive by optimizing (i) arrangement of multi-chip, full-color LEDs having excellent color rendering properties and single-chip, high-luminance white LEDs and (ii) intensity of light emitted by these LEDs.

### CITATION LIST

### Patent Literatures

Patent Literature 1
Japanese Patent Application Publication, Tokukai, No. 2007-86390 A (Publication Date: Apr. 5, 2007)
Patent Literature 2
Japanese Patent Application Publication, Tokukai, No. 2009-26672 A (Publication Date: Feb. 5, 2009)

### SUMMARY OF INVENTION

### Technical Problem

A conventional technique described in Patent Literature 1 is capable of saving power consumed by the LED backlight in the black display areas, in which no illumination is necessary by the backlight. Note however that, since the black display areas may change depending on an image to be displayed or depending on a display mode, an extremely complicated configuration is necessary to locally control ON and OFF states of LEDs. Further, the conventional technique described in Patent Literature 1 is a technique of locally controlling ON and OFF states of LEDs in the black display areas and locally controlling ON and OFF states of LEDs in other areas. That is, Patent Literature 1 does not at all suggest a technique of controlling display luminance over the entire display region.

A conventional technique described in Patent Literature 2 is capable of saving power consumed by the LED backlight, by employing a special way of (i) arranging different kinds of LEDs having different properties and (ii) controlling intensity of light emitted by the LEDs. However, according to such a technique, arrangement of the LEDs is complicated and the control of the intensity of light is also complicated. Further, as is the case with Patent Literature 1, the conventional technique described in Patent Literature 2 does not at all suggests a technique of controlling display luminance over the entire display region.

The present invention has been made in view of the problems, and a main object of the present invention is to provide a light source apparatus which is capable of, even in a case where the light source apparatus is to be driven in different luminance modes, being driven with low power consumption according to the luminance.

### Solution to Problem

In order to attain the above object, a liquid source apparatus in accordance with the present invention includes: a plurality of light emitting elements, said light source apparatus having a first luminance mode and a second luminance mode, the second luminance mode being a mode in which the light source apparatus is driven so that luminance is lower than luminance in the first luminance mode, the plurality of light emitting elements being classified into (i) a first group for use in the first luminance mode and (ii) a second group for use in the second luminance mode, and in a part of a light emitting element area, light emitting elements that belong to the second group being distributed less densely than light emitting elements that belong to the first group.

According to the configuration, in the second luminance mode in which the light source apparatus is driven so that luminance is lower, the luminance is controlled by using, in a part of the light emitting element area, fewer light emitting elements than those used in the first luminance mode. Therefore, power supplied to each light emitting element is substantially the same between the first luminance mode and the second luminance mode. This makes it possible to provide a light source apparatus which is capable, regardless of which luminance mode is selected, of optimizing (maximizing) efficiency of each light emitting element and thus capable of being driven with low power consumption.

The prevent invention further provides a display apparatus including, as a backlight, the light source apparatus described above.

### Advantageous Effects of Invention

The present invention provides a light source apparatus having a plurality of different luminance modes, which light source apparatus is capable of being driven with low power consumption by optimizing, regardless of which luminance mode is selected, the efficiency of each light emitting element.

### BRIEF DESCRIPTION OF DRAWINGS

FIG. 1 is a block diagram illustrating a configuration of a main part of a light source apparatus in accordance with Embodiment 1 of the present invention.

FIG. 2 is a flowchart illustrating an example of how to control operation of the light source apparatus shown in FIG. 1.

FIG. 3 is an enlarged view schematically illustrating a light source section of the light source apparatus shown in FIG. 1.

FIG. 4 is another view schematically illustrating the light source section of the light source apparatus shown in FIG. 1.

FIG. 5 is a view, which is obtained when power is supplied to a light source by using one (1) power supply unit that includes a transformer, schematically illustrating a relation between level of load applied on the light source and efficiency.

FIG. 6 is a block diagram illustrating a configuration of a main part of a light source apparatus in accordance with Embodiment 2 of the present invention.

FIG. 7 is a flowchart illustrating an example of how to control operation of the light source apparatus shown in FIG. 6.

### DESCRIPTION OF EMBODIMENTS

### Embodiment 1

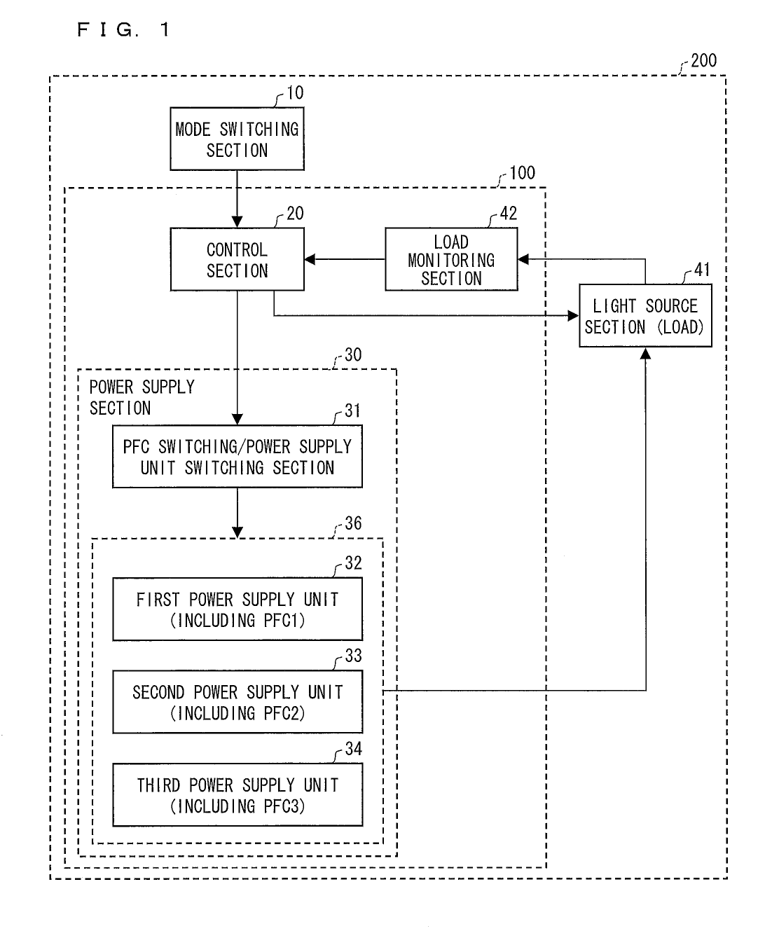

The following description discusses in detail the first embodiment of the present invention with reference to FIGS. 1 to 5.

(Configuration of Light Source Apparatus)

FIG. 1 is a block diagram schematically illustrating a configuration of a main part of a light source apparatus 200 in accordance with the present embodiment. In broad outline, the light source apparatus 200 is capable of efficiently supplying power according to each luminance mode, in a case where a light source section 41 to which power is supplied has (i) a first luminance mode (high-luminance drive mode/high-load drive mode) and (ii) a second luminance mode (low-luminance drive mode/low-load drive mode) in which the light source section 41 is to be driven so that luminance is lower (driven with lower load) than in the first luminance mode. The light source apparatus 200 can have three or more different luminance modes corresponding to respective different luminances. In this case, one of two luminance modes randomly chosen from the three or more luminance modes, in which the light source section 41 is to be driven so that luminance is higher, serves as the first luminance mode. On the other hand, the other of the two luminance modes, in which the light source section 41 is to be driven so that luminance is lower, serves as the second luminance mode.

The following description discusses the present embodiment on the assumption that the light source apparatus 200 is a backlight unit included in a liquid crystal television set (display apparatus, not illustrated).

The liquid crystal television set has display modes: a “moving image display mode” and an “ornamental image display mode”. In the moving image display mode, the liquid crystal television set displays a moving image such as a television image, a video image or a DVD image. In the ornamental image display mode, the liquid crystal television set displays a still image (ornamental image/wall picture image) such as a painting or a picture for ornamental purposes. In the moving image display mode, the light source section 41 is driven so that the luminance is for example as high as about 450 (cd/m²), for the purpose of for example improving visibility of a moving image. On the other hand, in the ornamental image display mode, the light source section 41 is driven so that the luminance is for example as low as about 150 (cd/m²), for the purpose of for example showing a still image as if it is a real painting or picture or bringing a still image into harmony with its surroundings.

That is, the light source apparatus 200 (more specifically, the light source section 41) has a high-luminance drive mode (first luminance mode/high-load drive mode) and a low-luminance drive mode (second luminance mode/low-load drive mode). The high-luminance drive mode corresponds to the moving image display mode. The low-luminance drive mode, in which the light source apparatus 200 is driven under a load lower than that in the high-luminance drive mode, corresponds to the ornamental image display mode. In terms of power consumption by the light source section 41, less power is consumed in the low-luminance drive mode than in the high-luminance drive mode.

The light source apparatus 200 includes a power supply section 30, a load monitoring section 42, a mode switching section 10, the light source section 41 and a control section 20. The power supply section 30, the load monitoring section 42, the mode switching section 10 and the control section 20 can be provided in a body of the liquid crystal television set so that they serve as constituents of the light source apparatus 200 when the light source apparatus 200 is incorporated in the liquid crystal television set.

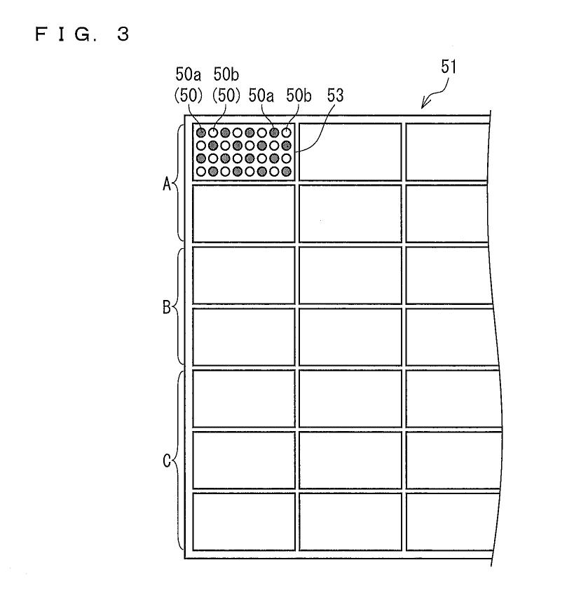

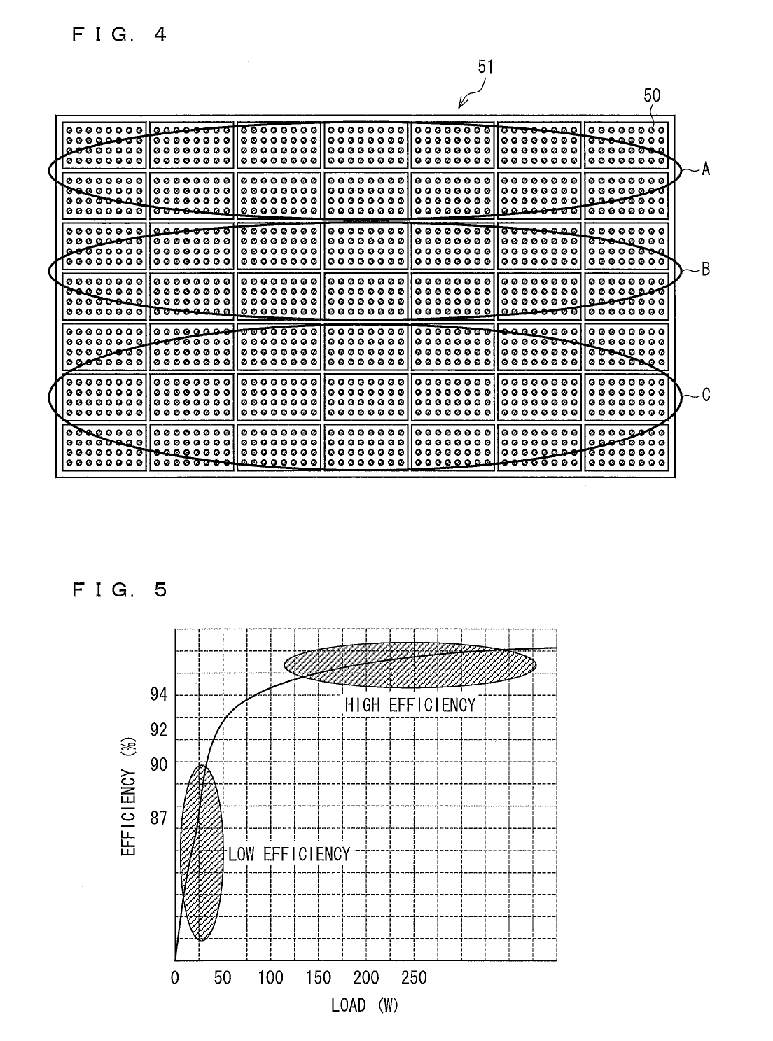

As illustrated in FIGS. 3 and 4, the light source section 41 includes a plurality of LEDs (light emitting elements) 50 arranged regularly in a matrix manner. A light emitting element area 51 of the light source section 41 includes a plurality of rectangular light emitting element substrates 53, in each of which two or more LEDs 50 are arranged in a lattice manner and which are regularly arranged horizontally and vertically. As illustrated in FIG. 3, the plurality of LEDs 50 are classified into a first group (including all the plurality of LEDs 50 shown in FIG. 3, i.e., all LEDs 50a and 50b) for use in the high-luminance drive mode and a second group (including all the LEDs 50b shown in FIG. 3) for use in the low-luminance drive mode. Note that, although FIG. 3 illustrates only LEDs 50a and 50b arranged in one of the light emitting element substrates 53, the others of the light emitting element substrates 53 each have the same arrangement of LEDs 50a and 50b.

Further, a wire and a drive circuit are provided to drive the LEDs 50 that belong to the first group and another wire and another drive circuit are provided to drive only the LEDs 50b that belong to the second group, so as to correspond to the above configuration. For example, the wire for driving the LEDs 50 that belong to the first group and the wire for driving only the LEDs 50b that belong to the second group are provided in respective different layers on a single LED substrate such that the wire for driving the LEDs 50 that belong to the first group is insulated from the wire for driving only the LEDs 50b. Moreover, in a part of the light emitting element area 51 in which the plurality of LEDs 50 are arranged, LEDs (LEDs 50b) that belong to the second group are distributed less densely than LEDs (LEDs 50) that belong to the first group. More specifically, some of the LEDs 50 that belong to the first group are used such that these some of the LEDs 50 are evenly distributed and account for a predetermined percentage (50% in the case of FIG. 3) of the LEDs 50. These some of the LEDs 50 are the LEDs 50b that belong to the second group.

Furthermore, for the purpose of for example achieving area active control (operation control in units of divided areas), the light emitting element area 51 of the light source section 41 is divided into three areas: an area A (divided area), an area B (divided area) and an area C (divided area). In each of the areas A to C, two or more LEDs (light emitting elements) 50 are arranged (refer to FIGS. 3 and 4) (described later).

The load monitoring section 42 constantly monitors variations in load (variations in luminance) applied on the light source section 41, and supplies the result of the monitoring to the control section 20. As used herein, the “variations in load” means for example a decrease in load due to switching from the high-luminance drive mode to the low-luminance drive mode or an increase in load due to switching from the low-luminance drive mode to the high-luminance drive mode. The monitoring of load can be carried out by a known method as appropriate. The load monitoring section can be provided in the liquid crystal television set as needed.

The control section 20 receives the result obtained by the load monitoring section 42 and information about a drive mode selected via the mode switching section 10. The control section 20 then generates a control signal in accordance with the result and/or the information thus received. The control section 20 controls operation of the power supply section 30 by the control signal. The mode switching section 10 is made up of for example (i) an input button provided to the liquid crystal television set or (ii) a receiver section (not illustrated) that receives input from a remote controller. A user selects the high-luminance drive mode or the low-luminance drive mode via the mode switching section 10.

The power supply section 30 includes a PFC switching/power supply unit switching section (power supply unit selection section/power-factor improvement circuit control section) 31 and a power supply unit section 36. The power supply unit section 36 includes three power supply units 32 to 34 (e.g., so-called power supply units which utilize transformers and have inverter-controlled power supply circuits, such as LLC resonant power supply units), each of which includes a transformer (so-called power supply transformer, not illustrated). Further, the power supply units 32 to 34 include respective power-factor improvement circuits PFC1 to PFC3 on primary sides of the transformers.

Each of the power supply units 32 to 34 includes a power supply circuit, and is thus capable of supplying power to the light source section 41 even on its own. According to the present embodiment, the power supply units 32 to 34 have substantially the same configurations. The power supply unit section 36 supplies power to the light source section 41, by using the power supply unit(s) 32, 33 and/or 34 depending on a luminance mode in which the light source section 41 is driven (described later). The power supply unit section 36 is configured to receive power from outside via a power supply adapter (not illustrated).

The PFC switching/power supply unit switching section receives the control signal generated by the control section 20. In accordance with the control signal, the PFC switching/power supply unit switching section 31 selects which of the power supply units 32 to 34 to use. The PFC switching/power supply unit switching section 31 further switches ON and OFF states of the power-factor improvement circuits PFC1 to PFC3 of the respective power supply units 32 to 34. That is, the PFC switching/power supply unit switching section 31 causes each of the power-factor improvement circuits PFC1 to PFC3 to operate or to stop operating.

(Details of Operation Control)

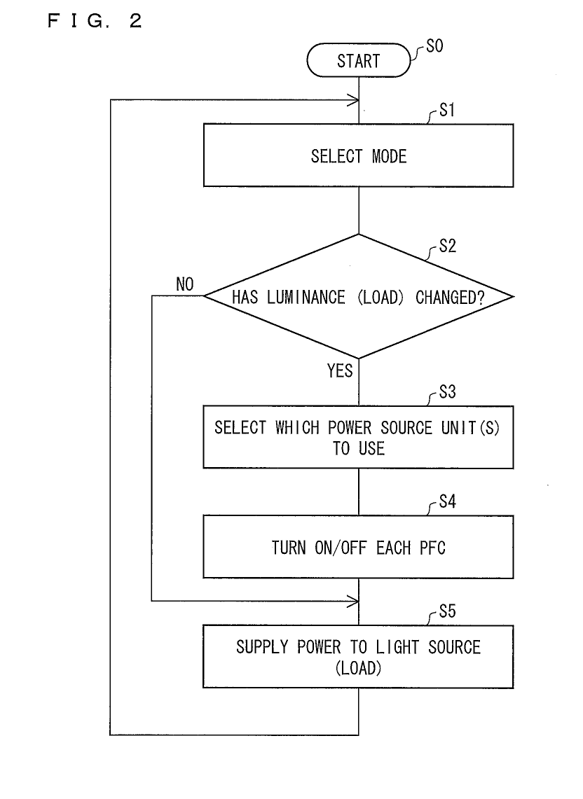

With reference to FIGS. 1 and 2, the following description discusses, in detail, how to control operation of the light source apparatus 200 shown in FIG. 1. FIG. 2 is a flowchart illustrating an example of how to control operation of the light source apparatus 200.

In Step S0, the liquid crystal television set is in the moving image display mode or in the ornamental image display mode.

Next, in Step S1, a user selects the moving image display mode or the ornamental image display mode via the mode switching selection 10 (see FIG. 1) of the liquid crystal television set. In a case where the moving image display mode is selected, the light source apparatus 200 drives the light source section 41 in the high-luminance drive mode. In a case where the ornamental image display mode is selected, the light source apparatus 200 drives the light source section 41 in the low-brightness drive mode.

In Step S2, the light source apparatus 200 (control section 20) determines whether or not surface luminance (load level) in the light source section 41 has changed due to the mode selection made in Step S1. For example, (1) the control section 20 can determine, upon receiving information from the mode switching section 10 notifying that a display mode different from an immediately preceding display mode is selected, that the surface luminance (load level) has changed or (2) the control section 20 can cause the load monitoring section 42 to constantly monitor the load applied on the light source section 41 and to supply the result of the monitoring to the control section 20 so as to determine that the surface luminance (load level) has changed when a change occurs in the result of the monitoring.

If it is determined in Step S2 that the surface luminance (load level) in the light source section 41 has not changed, the process proceeds to Step S5. Then, the light source apparatus 200 continues to supply power to the light source section 41 until another mode selection is made (that is, until Step S1 is carried out again).

If it is determined in Step S2 that the surface luminance (load level) in the light source section 41 has changed, the process proceeds to Step S3. Then, the light source apparatus 200 (PFC switching/power supply unit switching section 31) selects which of the power supply units 32 to 34 to use. For example, if it is determined in Step S2 that the load on the light source section 41 has decreased (that is, the high-luminance drive mode has been changed to the low-luminance drive mode), the PFC switching/power supply unit switching section 31 changes a state in which power is supplied by using all the three power supply units 32 to 34 to a state in which power is supplied by using only the power supply unit 32. On the other hand, if it is determined in Step S2 that the load on the light source section 41 has increased (that is, the low-luminance drive mode has been changed to the high-luminance drive mode), the PFC switching/power supply unit switching section 31 changes the state in which power is supplied by using only the power supply unit 32 to the state in which power is supplied by using all the three power supply units 32 to 34.

In the high-luminance drive mode, the power supply unit 32 supplies power to all LEDs 50 arranged in the area A, the power supply unit 33 supplies power to all LEDs 50 arranged in the area B, and the power supply unit 34 supplies power to all LEDs 50 arranged in the area C (these areas are shown in FIGS. 3 and 4). On the other hand, in the low-luminance drive mode, the power supply unit 32 supplies power to all the LEDs 50b, which belong to the second group and are distributed all over the areas A to C (see FIG. 3). The luminance (light intensity) of each LED 50 in the high-luminance drive mode and the luminance (light intensity) of each LED 50 (each LED 50b) in the low-luminance mode are set to be substantially the same. Note however that, as described earlier, only part of the plurality of LEDs 50 (i.e., only the LEDs 50b) are used in the low-luminance drive mode. Therefore, the light source section 41 as a whole (i) is driven so that luminance is lower than in the high-luminance drive mode and (ii) consumes less power than in the high-luminance drive mode.

Next, the process proceeds to Step S4. The light source apparatus 200 (PFC switching/power supply unit switching section 31) determines whether or not to turn ON (i.e., whether or not to cause to operate) the power-factor improvement circuit(s) PFC1, PFC2 and/or PFC3 of the power supply unit(s) 32, 33 and/or 34 selected in Step S3. For example, if it is determined in Step S3 that all the power supply units 32 to 34 are to be used so as to correspond to the high-luminance drive mode, the PFC switching/power supply unit switching section 31 turns ON all the power-factor improvement circuits PFC1 to PFC3. On the other hand, if it is determined in Step S3 that only the power supply unit 32 is to be used so as to correspond to the low-luminance drive mode, the PFC switching/power supply unit switching section 31 turns OFF the power-factor improvement circuit PFC1 of the power supply unit 32.

Next, the process proceeds to Step S5. The light source apparatus 200 supplies power to the light source section 41 by using the power supply unit 32, 33 and/or 34 selected in Step S3. The light source apparatus 200 continues to supply power to the light source section 41 until another mode selection is made (that is, until Step S1 is carried out again).

(Improvement of Power Efficiency Under Low Load (Low Luminance))

The following description discusses, with reference to FIG. 5 etc., an example of an effect brought about by the light source apparatus 200 of the present invention. FIG. 5 is a graph schematically illustrating a relation between level of load applied on the light source (X axis) and power efficiency (Y axis), which relation is observed in a case where the light source (load) receives power from one (1) power supply unit (i.e., corresponding to the power supply unit 32) including a transformer. For example, assume that the light source (corresponding to the light source section 41) needs to be supplied with power of 400 W in the high-luminance drive mode corresponding to the moving image display mode, whereas the light source needs to be supplied with power of 75 W to 80 W in the low-luminance drive mode corresponding to the ornamental image display mode. That is, assume that the load applied on the light source during the low-luminance drive mode is about one fifth the load applied on the light source during the high-luminance drive mode.

As illustrated in FIG. 5, the efficiency of the power supply unit including the transformer decreases as the load applied on the light source decreases. That is, the percentage of power loss arising from an exciting current generated in the transformer with respect to the power output by the power supply unit increases as the load decreases. In addition, in a case where a plurality of power supply units cooperate together to supply power (75 W to 80 W) which is about one fifth the maximum power (400 W) (for example, in a case of sequentially supplying power to LEDs 50 in the area A, LEDs 50 in the area B and then to LEDs 50 in the area C by using all the respective power supply units 32 to 34), all the plurality of power supply units will be operated at “low efficiency” in FIG. 5.

In this regard, according to the light source apparatus 200 of the present invention, when the light source section 41 is driven in the low-luminance drive mode, total power required for the light source section 41 is supplied by using fewer power supply unit(s) 32, 33 and/or 34 (for example by using one (1) power supply unit 32 or two power supply units operating together) than those used in the high-luminance drive mode. This makes it possible to improve the efficiency of each power supply unit during the low-luminance drive mode, as compared to the case of using the power supply units as many as those used in the high-luminance drive mode. Accordingly, it is possible to for example display an ornamental image with lower power consumption. Further, since each power supply unit generates less heat, a design for heat release of each power supply unit or each power supply section can be simplified.

The light source apparatus 200 of the present invention is preferably configured such that a power supply unit (specifically, the power supply unit 32) that is for use both in the high-luminance drive mode and in the low-luminance drive mode operates at substantially the same load both in the high-luminance drive mode and in the low-luminance drive mode. This allows the power supply unit to operate under a substantially constant load condition regardless of drive modes. As such, it is possible to optimize the configuration of the power supply unit (in particular, the configuration of a power supply transformer) so that the power supply unit is suitable for that load condition.

### Other Embodiment

The above descriptions exemplified a configuration in which the PFC switching/power supply unit switching section 31 uses the power supply unit 32, 33 and/or 34 depending on a drive mode in which the light source section 41 is driven. Note however that, even in a case where all the power supply units 32 to 34 are used regardless of the drive modes, it is possible to reduce power consumption by merely switching ON and OFF states of the power-factor improvement circuits PFC1 to PFC3 depending on the drive mode.

Specifically, in the light source apparatus 200 shown in FIG. 1, the PFC switching/power supply unit switching section (power-factor improvement circuit control section) 31 (i) turns ON all the power-factor improvement circuits PFC1 to PFC3 while the light source section 41 is driven in the high-luminance drive mode (first luminance mode) but (ii) turns OFF at least one of, preferably all of the power-factor improvement circuits PFC1 to PFC3 while the light source section 41 is driven in the low-luminance drive mode (second luminance mode). In both the high-luminance drive mode and the low-luminance drive mode, the light source apparatus 200 supplies power to the light source section 41 by using all the power supply units 32 to 34.

The power efficiency (i.e., the percentage of power efficiently used in a power-factor improvement circuit with respect to supplied power) of each of the power-factor improvement circuits PFC1 to PFC3 is lower in the low-luminance drive mode, in which load is lower than that in the high-luminance mode. The efficiency remarkably decreases particularly in a case where a power-factor improvement circuit includes a coil. For the purpose of addressing this problem, at least one of the power-factor improvement circuits PFC1 to PFC3 is turned OFF (caused not to operate) only in the low-luminance drive mode so that loss (loss in MOS (Metal-oxide-semiconductor), loss in coil) in the circuit is suppressed.

### Embodiment 2

The following description discusses, with reference to

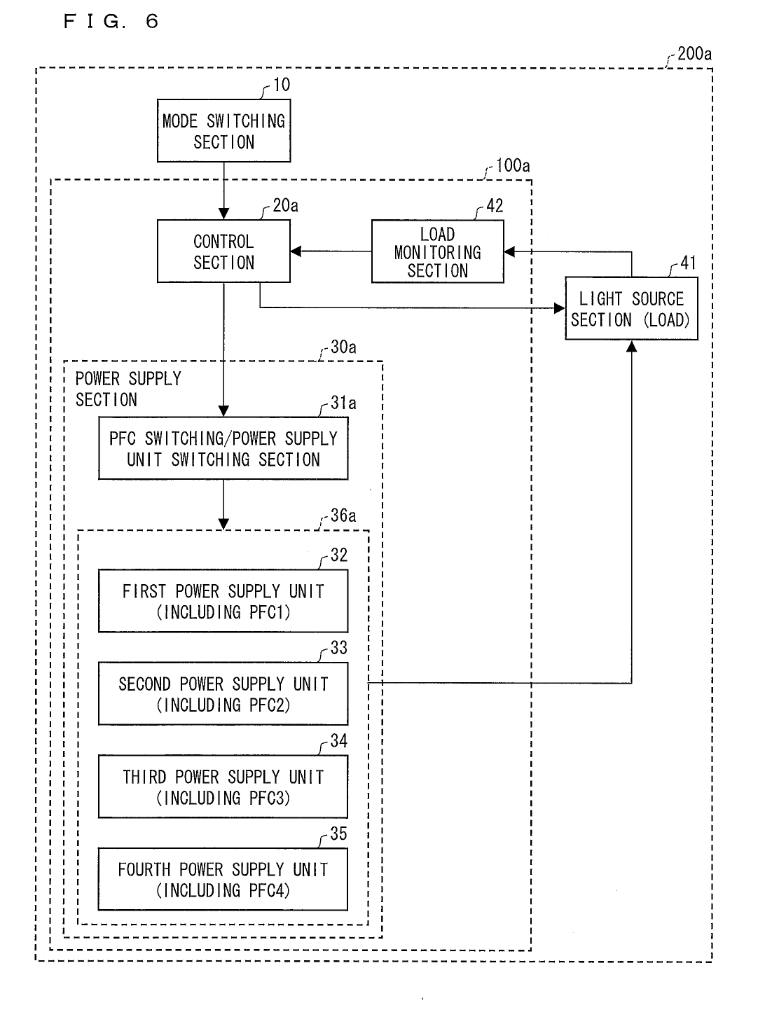

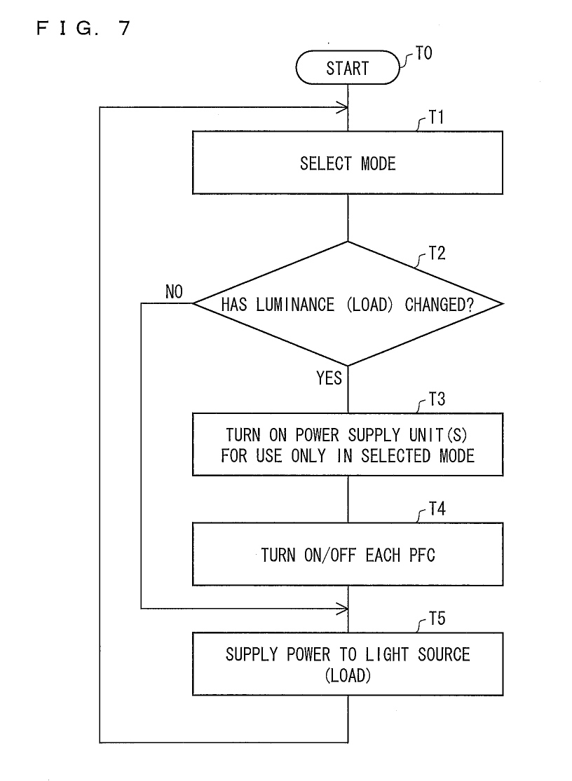

FIGS. 6 and 7, another embodiment of the present invention in detail.

(Configuration of Light Source Apparatus)

FIG. 6 is a block diagram schematically illustrating a configuration of a main part of a light source apparatus 200a in accordance with the present embodiment. Note that, members in FIG. 6 that are assigned referential numerals identical to those shown in FIG. 1 are the same as those shown in FIG. 1, and their descriptions are omitted here.

In broad outline, as is the case with the light source apparatus 200 described in Embodiment 1, the light source apparatus 200a is capable of efficiently supplying power according to each luminance mode, in a case where an electronic device to which power is supplied has a first luminance mode (high-load drive mode/high-luminance drive mode) and a second luminance mode (low-load drive mode/low-luminance drive mode) in which the electronic device is to be driven so that load is lower than that in the first luminance mode. Specifically, the present embodiment is for example characterized in that (i) during the high-luminance drive mode, the light source apparatus 200a supplies power by using all the power supply units 32 to 34 which are for use only in the high-luminance drive mode (that is, without using a power supply unit 35) and (ii) during the low-luminance drive mode, the light source apparatus 200a supplies power by using only the power supply unit 35 which is for use only in the low-luminance drive mode.

The light source apparatus 200a includes a power supply section 30a, a load monitoring section 42, a mode switching section 10, a light source section 41 and a control section 20a. The power supply section 30a, the load monitoring section 42, the mode switching section 10 and the control section 20a can be provided in a body of the liquid crystal television set so that they serve as constituents of the light source apparatus 200a when the light source apparatus 200a is incorporated in the liquid crystal television set.

The control section 20a receives the result obtained by the load monitoring section 42 and information about a drive mode selected via the mode switching section 10. The control section 20a then generates a control signal in accordance with the result and/or the information thus received. The control section 20a controls operation of the power supply section 30a by the control signal.

The power supply section 30a includes a PFC switching/power supply unit switching section (power supply unit selection section/power-factor improvement circuit control section) 31a and a power supply unit section 36a. The power supply unit section 36a includes four power supply units 32 to 35, each of which includes a transformer (not illustrated). Further, the power supply units 32 to 35 include respective power-factor improvement circuits PFC1 to PFC4.

The power supply unit 35 is a power supply unit for use only in the second luminance mode (low-load drive mode). The power supply unit 35 is configured such that, under a load condition equivalent to the second luminance mode, a loss arising from an exciting current in the transformer is smaller than those in the power supply units 32 to 34 (i.e., the power supply units for use only in the first luminance mode). This makes it possible to improve the use efficiency of power, as compared to the case where power is supplied by using the same power supply unit(s) in all the luminance modes.

Specifically, for example, in a case where cores are made from the same material, a core of the transformer included in the power supply unit 35 is configured to be smaller than those of the transformers included in the power supply units 32 to 34. Alternatively, in a case where the cores have the same shape, the core of the transformer included in the power supply unit 35 is made from a material that has so-called iron loss less than those occurring in the cores of the transformers included in the power supply units 32 to 34. That is, it is possible to achieve the above configuration by controlling the material for the cores of the transformers included in the power supply units 32 to 35 and/or the shapes of the cores of the transformers included in the power supply units 32 to 35.

Generally, a loss arising from an exciting current in a transformer is broadly divided into copper loss (loss occurring in a coil) and iron loss (loss occurring in a core). The transformer included in the power supply unit 35 is not limited provided that, under a load condition equivalent to the second luminance mode, at least one of the above losses is/are smaller than those occurring in the transformers included in the power supply units 32 to 34. It is more preferable that, as described earlier, the iron loss be reduced. This is because the iron loss becomes more dominant as the load decreases.

From a different point of view, the power supply unit 35 is preferably configured such that, under a load condition equivalent to the second luminance mode, the percentage of loss arising from an exciting current in a transformer, i.e., the percentage found by “Loss (Unit: W)/Supplied power (Unit: W)×100”, is not greater than 20%, and more preferably not greater than 10%.

The PFC switching/power supply unit switching section 31a receives the control signal generated by the control section 20a. In accordance with the control signal, the PFC switching/power supply unit switching section 31a selects which of the power supply units 32 to 35 is/are to be used. The PFC switching/power supply unit switching section 31a further switches ON and OFF states of the power-factor improvement circuits PFC1 to PFC4 of the respective power supply units 32 to 35.

(Details of Operation Control)

With reference to FIGS. 6 and 7, the following description discusses, in detail, how to control operation of the light source apparatus 200a. FIG. 7 is a flowchart illustrating an example of how to control operation of the light source apparatus 200a.

In Step T0, the liquid crystal television set is in the moving image display mode or in the ornamental image display mode.

Next, in Step T1, a user selects the moving image display mode or the ornamental image display mode via the mode switching selection 10 (see FIG. 6) of the liquid crystal television set. In a case where the moving image display mode is selected, the light source apparatus 200a drives the light source section 41 in the high-luminance drive mode. In a case where the ornamental image display mode is selected, the light source apparatus 200a drives the light source section 41 in the low-brightness drive mode.

In Step T2, the light source apparatus 200a (control section 20a) determines whether or not the level of a load applied on the light source section 41 has changed due to the mode selection made in Step T1. The determination is made in the same manner as in Embodiment 1. Therefore, its detailed description is omitted here.

If it is determined in Step T2 that the level of the load applied on the light source section 41 has not changed, the process proceeds to Step T5. Then, the light source apparatus 200a continues to supply power to the light source section 41 until another mode selection is made (that is, until Step T1 is carried out again).

If it is determined in Step T2 that the level of the load applied on the light source section 41 has changed, the process proceeds to Step T3. Then, the light source apparatus 200a (PFC switching/power supply unit switching section 31a) selects which of the power supply units 32 to 35 to use so as to correspond to a selected mode. For example, if it is determined in Step T2 that the load applied on the light source section 41 has decreased (that is, the high-luminance drive mode has been changed to the low-luminance drive mode), the PFC switching/power supply unit switching section 31a changes a state in which power is supplied by using the three power supply units 32 to 34 to a state in which power is supplied by using only the power supply unit 35. On the other hand, if it is determined in Step T2 that the load applied on the light source section 41 has increased (that is, the low-luminance drive mode has been changed to the high-luminance drive mode), the PFC switching/power supply unit switching section 31a changes the state in which power is supplied by using only the power supply unit 35 to the state in which power is supplied by using the three power supply units 32 to 34.

Next, the process proceeds to Step T4. The light source apparatus 200a (PFC switching/power supply unit switching section 31a) determines whether or not to turn ON (i.e., whether or not to cause to operate) the power-factor improvement circuit(s) PFC1, PFC2, PFC3 and/or PFC4 of the power supply unit(s) 32, 33, 34 and/or 35 selected in Step T3. For example, if it is determined in Step T3 that the power supply units 32 to 34 are to be used so as to correspond to the high-luminance drive mode, the PFC switching/power supply unit switching section 31a turns ON all the power-factor improvement circuits PFC1 to PFC3. On the other hand, if it is determined in Step T3 that only the power supply unit 35 is to be used so as to correspond to the low-luminance drive mode, the PFC switching/power supply unit switching section 31a turns OFF the power-factor improvement circuit PFC4 of the power supply unit 35.

Next, the process proceeds to Step T5. The light source apparatus 200 supplies power to the light source section 41 by using the power supply unit(s) 32, 33, 34 and/or 35 selected in Step T3. The power supply apparatus 200a then continues to supply power to the light source section 41 until another mode selection is made (that is, until Step T1 is carried out again).

As has been described, a light source apparatus in accordance with the present embodiment includes, in order to for example improve efficiency of a liquid crystal television set during the ornamental image display mode, a power supply unit that is for use only in the ornamental image display mode. Since a load applied during the ornamental image display mode is constant, the light source apparatus preferably includes a power supply unit configured exclusively for that load so that efficiency is increased. Further, power supply units other than this exclusive power supply unit are all turned OFF during the ornamental image display mode.

### Embodiment 3

Embodiments 1 and 2 each exemplified a configuration of a light source apparatus which (i) includes a plurality of power supply units and (ii) selectively uses as appropriate the power supply unit(s) in the high-luminance drive mode (first luminance mode) and in the low-luminance drive mode (second luminance mode).

Note that the light source apparatus can be configured such that (i) only one power supply unit is provided and (ii) the power supply unit is used both in the high-luminance drive mode (first luminance mode) and in the low-luminance drive mode (second luminance mode). Specifically, for example, the light source apparatus 200 shown in FIG. 1 can be configured such that only the power supply unit 34 is provided instead of the plurality of power supply units 32 to 34.

Alternatively, the light source apparatus can be configured such that (i) two power supply units are provided and (ii) one of the power supply units is used in the high-luminance drive mode and the other is used in the low-luminance drive mode. In this case, each of the power supply units is controlled, depending on a drive mode, such that the percentage of loss arising from an exciting current in a transformer is preferably not greater than 10%.

Embodiments 1 and 2 each exemplified a light source apparatus included in a liquid crystal television set. Note, however, that this does not imply any limitation. For example, the light source apparatus is applicable to a large, flat television set or an ultraslim television set including a backlight (i.e., television sets having limitations on their structures). Further, the number of divided areas shown in FIG. 4 and the number of power supply units shown in FIGS. 1 and 6 are mere examples, and can be changed as needed.

A light source apparatus (1) in accordance with the present invention is a light source apparatus including a plurality of light emitting elements, said light source apparatus having a first luminance mode and a second luminance mode, the second luminance mode being a mode in which the light source apparatus is driven so that luminance is lower than luminance in the first mode, the plurality of light emitting elements being classified into (i) a first group for use in the first luminance mode and (ii) a second group for use in the second luminance mode, and in a part of a light emitting element area, light emitting elements that belong to the second group being distributed less densely than light emitting elements that belong to the first group.

A light source apparatus (2) in accordance with the present invention, which is premised on the configuration of the light source apparatus (1), can be configured such that the light emitting element area includes a plurality of divided areas, and can further include: a plurality of power supply units each of which includes a transformer; and a power supply unit selection section for selecting, depending on a luminance mode, which of the plurality of power supply units is/are to be used, the power supply unit selection section making a selection such that only one or some of the plurality of power supply units which are used in the first luminance mode is/are used in the second luminance mode, in the first luminance mode, each of the plurality of power supply units supplying power to one of the plurality of divided areas, and in the second luminance mode, (i) said some of the plurality of power supply units operating together to supply power to all the plurality of divided areas or (ii) said only one of the plurality of power supply units supplying power to all the plurality of divided areas.

Loss occurring in a transformer is substantially constant regardless of load levels. Therefore, the percentage of loss with respect to the total power supplied increases (that is, the use efficiency of power decreases) as the load decreases. In this regard, according to the above configuration, in the second luminance mode in which luminance is lower (load is lower), total power required is supplied by using fewer power supply units than those used in the first luminance mode. This makes it possible to cause each of the power supply units to operate more efficiently as compared to the case where power is supplied by using all the power supply units. That is, it is possible to drive each of the power supply units efficiently according to the luminance modes in which loads are different.

The light source apparatus (2) is preferably configured such that a power supply unit(s) that is/are used both in the first luminance mode and in the second luminance mode operate(s) at substantially the same load both in the first luminance mode and in the second luminance mode. According to the configuration, the power supply unit(s) operate(s) at substantially constant load regardless of the luminance modes. This makes it possible to optimize a configuration of the power supply unit(s) (in particular, a configuration of a power supply transformer(s)) so that the configuration is suitable for that load.

A light source apparatus (3) in accordance with the present invention, which is premised on the configuration of the light source apparatus (1), preferably further includes: a second power supply unit for supplying power only to the light emitting elements that belong to the second group, the second power supply unit being intended for use only in the second luminance mode; and a first power supply unit for supplying power only to the light emitting elements that belong to the first group, the first power supply unit being intended for use only in the first luminance mode.

According to the configuration, there is no power supply unit that is used both in the first luminance mode and in the second luminance mode. Therefore, it is possible to (i) more suitably configure the first power supply unit for use in the first luminance mode according to the load applied in the first luminance mode and (ii) more suitably configure the second power supply unit for use in the second luminance mode according to the load applied in the second luminance mode. This makes it possible to provide a light source apparatus which is capable of being driven with low power consumption in both luminance modes.

A light source apparatus (4) in accordance with the present invention, which is premised on the configuration of the light source apparatus (3), can further be configured such that the second power supply unit is configured such that, under a load condition equivalent to the second luminance mode, the second power supply unit suffers less power loss than the first power supply unit, the power loss arising from an exciting current generated in a transformer.

A light source apparatus (5) in accordance with the present invention, which is premised on the configuration of the light source apparatus (1), can be configured such that the light emitting element area includes a plurality of divided areas, and can further include: a plurality of power supply units each of which includes a transformer; and a power supply unit selection section for selecting, depending on a luminance mode, which of the plurality of power supply units is/are to be used, the plurality of power supply units being constituted by (i) a second power supply unit for supplying power only to the light emitting elements that belong to the second group, the second power supply unit being intended for use only in the second luminance mode and (ii) a first power supply unit for supplying power only to the light emitting elements that belong to the first group, the first power supply unit being intended for use only in the first luminance mode, and the power supply unit selection section making a selection such that (a) only the second power supply unit is used in the second luminance mode and (b) only the first power supply unit is used in the first luminance mode.

The light source apparatuses (1) to (5) in accordance with the present invention can each serve as for example a backlight for use in a display apparatus, and each can be configured such that: the first luminance mode is a luminance mode for displaying a moving image; and the second luminance mode is a luminance mode for displaying a still image.

The present invention is not limited to the descriptions of the respective embodiments, but may be altered within the scope of the claims. An embodiment derived from a proper combination of technical means disclosed in different embodiments is encompassed in the technical scope of the invention.

### INDUSTRIAL APPLICABILITY

The present invention provides a light source apparatus having a plurality of different luminance modes, which light source apparatus is capable of being driven with low power consumption.

### REFERENCE SIGNS LIST

31, 31a PFC switching/power supply unit switching section (Power supply unit selection section)
32 to 34 Power supply unit (Power supply unit for use only in first luminance mode/power supply unit)
35 Power supply unit (Power supply unit for use only in second luminance mode/power supply unit)
41 Light source section
50 LED (Light emitting element)
50a, 50b LED (Light emitting element belonging to first group)
50b LED (Light emitting element belonging to second group)
51 Light emitting element area
200, 200a Light source apparatus
A to C Divided areas

1. A light source apparatus comprising a plurality of light emitting elements,
said light source apparatus having a first luminance mode and a second luminance mode, the second luminance mode being a mode in which the light source apparatus is driven so that luminance is lower than luminance in the first luminance mode,
the plurality of light emitting elements being classified into (i) a first group for use in the first luminance mode and (ii) a second group for use in the second luminance mode, and
in a part of a light emitting element area where the plurality of light emitting elements are provided, light emitting elements that belong to the second group being distributed less densely than light emitting elements that belong to the first group.

2. A light source apparatus according to claim 1, wherein the light emitting element area includes a plurality of divided areas each of which includes a light emitting element,
said light source apparatus, further comprising:
a plurality of power supply units for supplying power to the plurality of light emitting elements, each of the plurality of power supply units including a transformer; and
a power supply unit selection section for selecting, depending on a luminance mode, which of the plurality of power supply units is/are to be used,
the power supply unit selection section making a selection such that only one or some of the plurality of power supply units which are used in the first luminance mode is/are used in the second luminance mode,
in the first luminance mode, each of the plurality of power supply units supplying power to one of the plurality of divided areas, and
in the second luminance mode, (i) said some of the plurality of power supply units operating together to supply power to all the plurality of divided areas or (ii) said only one of the plurality of power supply units supplying power to all the plurality of divided areas.

3. The light source apparatus according to claim 2, wherein a power supply unit(s) that is/are used both in the first luminance mode and in the second luminance mode operate(s) at substantially the same load both in the first luminance mode and in the second luminance mode.

4. A light source apparatus according to claim 1, further comprising:
a second power supply unit for supplying power only to the light emitting elements that belong to the second group, the second power supply unit being intended for use only in the second luminance mode; and
a first power supply unit for supplying power only to the light emitting elements that belong to the first group, the first power supply unit being intended for use only in the first luminance mode.

5. The light source apparatus according to claim 4, wherein the second power supply unit is configured such that, under a load condition equivalent to the second luminance mode, the second power supply unit suffers less power loss than the first power supply unit, the power loss arising from an exciting current generated in a transformer.

6. The light source apparatus according to claim 5, wherein a transformer of the second power supply unit has less iron loss than a transformer of the first power supply unit.

7. A light source apparatus according to claim 1, wherein the light emitting element area includes a plurality of divided areas each of which includes a light emitting element,
said light source apparatus, further comprising:
a plurality of power supply units for supplying power to the plurality of light emitting elements, each of the plurality of power supply units including a transformer; and
a power supply unit selection section for selecting, depending on a luminance mode, which of the plurality of power supply units is/are to be used,
the plurality of power supply units being constituted by (i) a second power supply unit for supplying power only to the light emitting elements that belong to the second group, the second power supply unit being intended for use only in the second luminance mode and (ii) a first power supply unit for supplying power only to the light emitting elements that belong to the first group, the first power supply unit being intended for use only in the first luminance mode, and
the power supply unit selection section making a selection such that (a) only the second power supply unit is used in the second luminance mode and (b) only the first power supply unit is used in the first luminance mode.

8. The light source apparatus according to claim 1, which serves as a backlight for use in a display apparatus, wherein:
the first luminance mode is a luminance mode for displaying a moving image; and
the second luminance mode is a luminance mode for displaying a still image.

9. The light source apparatus according to claim 1, wherein the light emitting elements that belong to the second group for use in the second luminance mode are some of the light emitting elements that belong to the first group for use in the first luminance mode.

10. A display apparatus comprising, as a backlight, a light source apparatus recited in claim 1.
